(19) United States
(12) Patent Application Publication
(10) Pub. No.: US 2013/0294781 A1
(43) Pub. Date: Nov. 7, 2013

(54) DATA TRANSMISSION SYSTEM AND OPTICAL DATA CABLE

(71) Applicant: CHEN-YU YU, Tu-Cheng (TW)

(72) Inventor: CHEN-YU YU, Tu-Cheng (TW)

(73) Assignee: HON HAI PRECISION INDUSTRY CO., LTD., Tu-Cheng (TW)

(21) Appl. No.: 13/595,085

(22) Filed: Aug. 27, 2012

(30) Foreign Application Priority Data
May 2, 2012 (TW) 101115498

(51) Int. Cl. G02B 6/44; H04B 10/12

(52) U.S. Cl. 398/141; 385/101

(57) ABSTRACT

A data transmission system includes a first electronic device, a second electronic device, and a detachable optical data cable. The first electronic device and the second electronic device, both include a processor. The optical data cable includes a first connecting member, a second connecting member, and a signal transmitting cable. The first connecting member includes a first photoelectric conversion module, and the second connecting member includes a second photoelectric conversion module. The optical signal transmitting cable includes an optical fiber and an electrical wire. The optical fiber connect with the two photoelectric conversion modules. The processor of the first electronic device includes an electrical power emitting module, for emitting electrical power from the first electronic device to the second inserting port via the electrical wire of the optical data cable, to start the second photoelectric conversion module. The present disclosure further provides an optical data cable.

### BACKGROUND

1. Technical Field

The present disclosure relates to data transmission systems, particularly to a data transmission system transmitting optical signals and an optical data cable being employed.

2. Description of Related Art

A data cable may be used to connect together two electronic devices for the transmission of data between the two electronic devices. Optical fiber cables transmit optical signals quickly; therefore, the optical fiber cables have become popular for transmitting data between electronic devices. However, when either of the electronic devices is a slave device, such as an USB flash drive, for example, the optical fiber cables cannot transmit data between the aforementioned electronic devices.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a data transmission system including an optical data cable.

FIG. 2 is a block diagram of the data transmission system shown in FIG. 1.

FIG. 3 is a sectional, isometric view of the optical data cable shown in FIG. 1.

### DETAILED DESCRIPTION

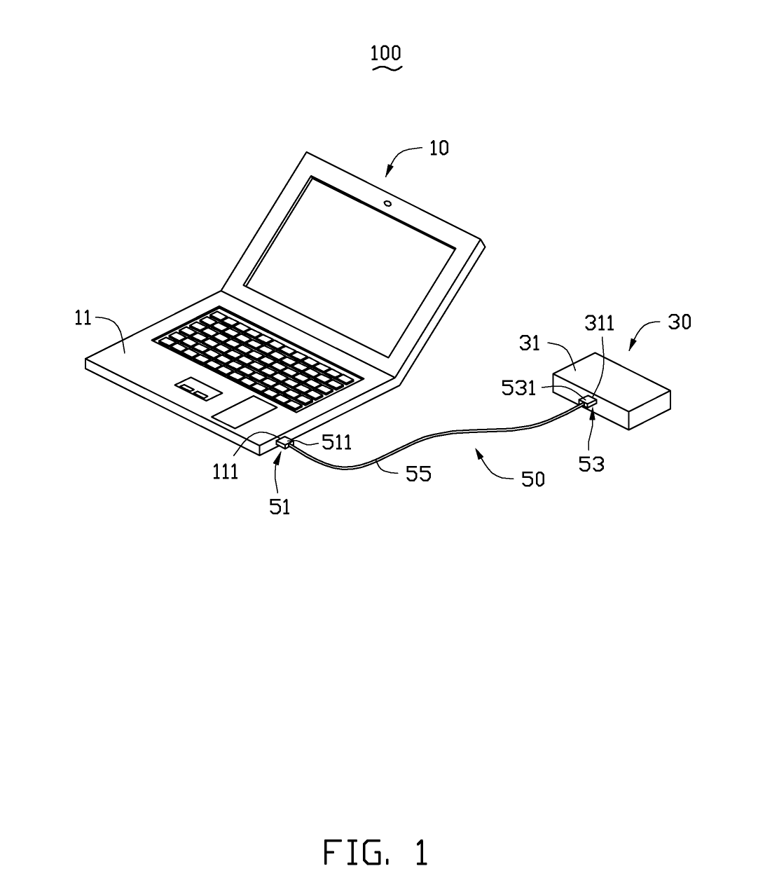

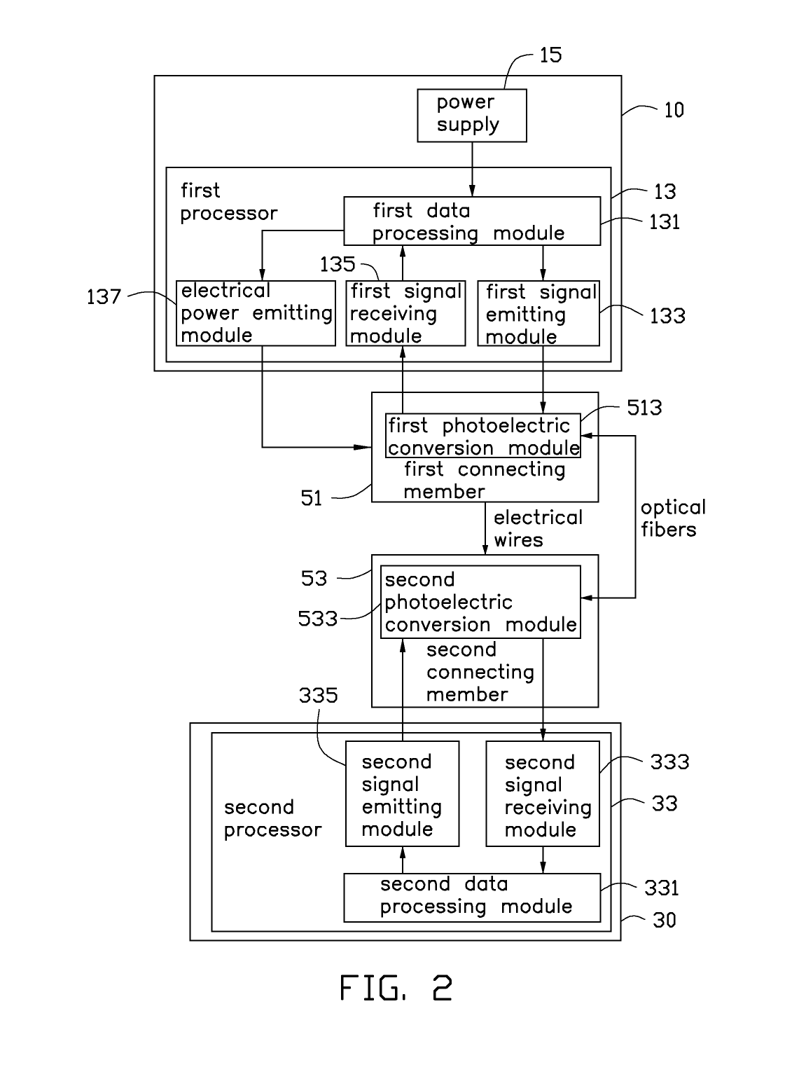

FIGS. 1 and 2 show an embodiment of a data transmission system 100. The data transmission system 100 includes a first electronic device 10, a second electronic device 30, and an optical data cable 50. The optical data cable 50 detachably connects the first electronic device 10 and the second electronic device 30, for transmitting data between the first electronic device 10 and the second electronic device 30. The first electronic device 10 can obtain electrical power from an outer electrical power source (not shown), such as a notebook, a tablet computer, a desktop computer for example. The second electronic device 30 cannot obtain electrical power from an outer electrical power source (not shown), such as a USB flash drive, a portable hard disk or a MP3 player, for example. In the illustrated embodiment, the first electronic device 10 is a notebook, and the second electronic device 30 is a portable hard disk. The optical data cable 50 connects the notebook, the first electronic device 10, with the portable hard disk , the second electronic device 30, for transmitting data.

The first electronic device 10 includes a main body 11, a first processor 13 (shown in FIG. 2), and a power supply 15 (shown in FIG. 2). The first processor 13 and the power supply 15 are received in the main body 11. The power supply 15 electrically connects with the first processor 13, and provides electrical power to the first processor 13.

The main body 11 defines a first inserting port 111 at a sidewall thereof, for allowing the optical data cable 50 to be inserted in. The first processor 13 includes a first data processing module 131, a first signal emitting module 133, a first signal receiving module 135, and an electrical power emitting module 137. The first signal emitting module 133, the first signal receiving module 135, and the electrical power emitting module 137 are electrically connected to the first data processing module 131, and are electrically connected to the first inserting port 111 via copper wires (not shown), respectively. The power supply 15 is electrically connected to the first data processing module 131, for providing electrical power to the first data processing module 131. In other embodiment, the power supply 15 can be an outer electrical power source. The electrical power emitting module 137 can be directly connected to the power supply 15.

The second electrical device 30 includes a base body 31 and a second processor 33. The base body 31 defines a second inserting port 311, for allowing the optical data cable 50 to be inserted in. The second processor 33 includes a second data processing module 331, a second signal receiving module 333, and a second signal emitting module 335; the second processor 33 is received in the base body 31. The second signal receiving module 333 and the second signal emitting module 335 are electrically connected to the second data processing module 331, and are electrically connected to the second inserting port 311 via copper wires (not shown), respectively.

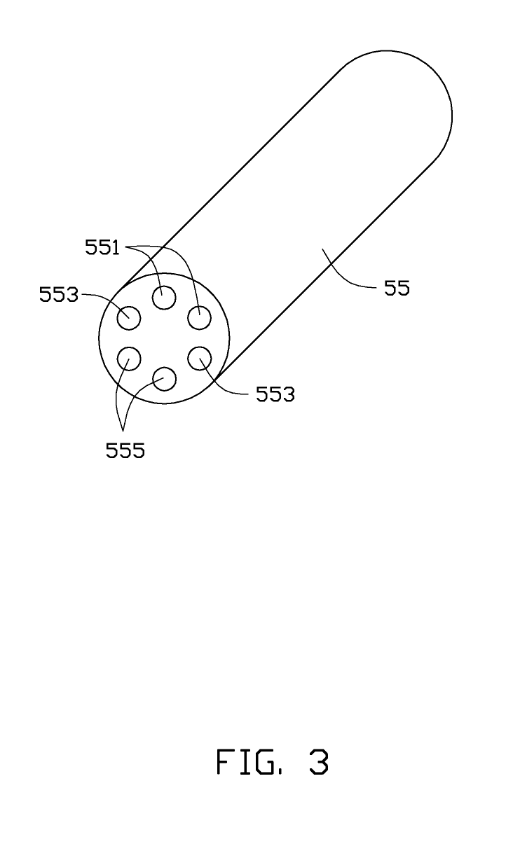

Referring to FIGS. 1 and 3, the optical data cable 50 of the embodiment is shown. The optical data cable 50 includes a first connecting member 51, a second connecting member 53, and a signal transmitting cable 55 connecting the first connecting member 51 and the second connecting member 53. The first connecting member 51 and the second connecting member 53 are located at two opposite ends of the signal transmitting cable 55. The first connecting member 51 is electrically connected to the first signal emitting module 133, the first signal receiving module 135 and the electrical power emitting module 137 when inserted into the first inserting port 111. The second connecting member 53 is electrically connected to the second signal emitting module 335 and the second signal receiving module 333 when inserted into the second inserting port 311.

The first connecting member 51 includes a first housing 511 and a first photoelectric conversion module 513 (shown in FIG. 2) mounted in the first housing 511. The second connecting member 53 includes a second housing 531 and a second photoelectric conversion module 533 (shown in FIG. 2) mounted in the second housing 531. When the first connecting member 51 is inserted into the first inserting port 111, the first photoelectric conversion module 513 is electrically connected to the first signal emitting module 133, the first signal receiving module 135 and the electrical power emitting module 137. When the second connecting member 53 is inserted into the second inserting port 311, the second photoelectric conversion module 533 is electrically connected to the second signal emitting module 335 and the second signal receiving module 333.

The signal transmitting cable 55 includes at least one optical fiber 551, at least one electrical wire 553, and at least one ground wire 555. The two distal ends of the optical fiber 551 are connected to the first photoelectric conversion module 513 and the second photoelectric conversion module 533, respectively. The two distal ends of the electrical wire 553 and the ground wire 555 extend from the first connecting member 51 to the second connecting member 53, respectively. The end of the electrical wire 553 near to the second connecting member 53 connects with the second photoelectric conversion module 533. When the first connecting member 51 is inserted into the first inserting port 111, the end of the electrical wire 553 near to the first connecting member 51 connects with the electrical power emitting module 137. In the embodiment, there are two optical fibers 551, two electrical wires 553, and two ground wires 555. The optical fibers 551 are active optical fibers. The two electrical wires 553 are for transmitting electrical power of different voltages, to suit the needs of different electronic devices.

In use, the first connecting member 51 is inserted into the first inserting port 111, and the second connecting member 53 is inserted into the second inserting port 311. The electrical power emitting module 137 emits electrical power provided by the power supply 15 to the second connecting member 53 via the first connecting member 51 and the electrical wires 553 to start the second photoelectric conversion module 533. The first signal emitting module 133 emits electrical signals from the first data processing module 131 to the first photoelectric conversion module 513, and the first photoelectric conversion module 513 converts the electrical signals to optical signals. The optical fibers 551 transmits the optical signals to the second photoelectric conversion module 533, and the second photoelectric conversion module 533 converts the optical signals to electrical signals, and the electrical signals are transmitted to the second data processing module 331. Therefore, the data of the first electronic device 10 is transmitted to the second electronic device 30. The data of the second electronic device 30 can be transmitted to the first electronic device 10 using the same way as aforementioned. During the transmission of data, the ground wires 555 ensure safety when transmitting electrical power.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A data transmission system, comprising:
a first electronic device defining a first inserting port, and comprising a first processor;
a second electronic device defining a second inserting port, and comprising a second processor; and
an optical data cable comprising a first connecting member, a second connecting member, and a signal transmitting cable, the signal transmitting cable connecting the first connecting member and the second connecting member, the first connecting member comprising a first photoelectric conversion module, the second connecting member comprising a second photoelectric conversion module, the first connecting member detachably connected to the first inserting port, and the first photoelectric conversion module electrically connected to the first processor, the second connecting member detachably connected to the second inserting port, and the second photoelectric conversion module electrically connected to the second processor, the signal transmitting cable comprising at least one optical fiber and at least one electrical wire, the at least one optical fiber connecting with the first photoelectric conversion module and the second photoelectric conversion module, an end of the at least one electrical wire electrically connected to the second photoelectric conversion module;
wherein the at least one optical fiber is configured to transmit optical signals, the first photoelectric conversion module and the second photoelectric conversion module are configured to convert electrical signals to optical signals or convert optical signals to electrical signals, the first processor comprises an electrical power emitting module, the electrical power emitting module is capable of emitting electric power of the first electronic device to the second photoelectric conversion module via the at least one electrical wire, to start the second photoelectric conversion module.

2. The data transmission system of claim 1, wherein the first electronic device is capable of obtaining electrical power from an outer electrical power source, and the second electronic device cannot obtain electrical power from an outer electrical power source.

3. The data transmission system of claim 2, wherein the first electronic device comprises a main body, and the first processor is received in the main body, the second electronic device comprises a base body, and the second processor is received in the base body, the first processor is electrically connected to the first inserting port, the second processor is electrically connected to the second inserting port.

4. The data transmission system of claim 1, wherein the first processor further comprises a first data processing module, a first signal receiving module, and a first signal emitting module, the first signal emitting module and the first signal receiving module are electrically connected to the first data processing module, and are electrically connected to the first inserting port, the first signal emitting module emits electrical signals to the first photoelectric conversion module, and the first photoelectric conversion module converts the electrical signals to optical signals to be transmitted by the at least one optical fiber; the first photoelectric conversion module converts the optical signals transmitted by the at least one optical fiber to electrical signals, and the first signal receiving module receives the electrical signals.

5. The data transmission system of claim 4, wherein the first electronic device further provides a power supply, the power supply electrically connects with the first data processing module.

6. The data transmission system of claim 5, wherein the electrical power emitting module electrically connects with the first data processing module, the electrical power emitting module emits electrical power provided by the power supply, and transmitted via the electrical wire.

7. The data transmission system of claim 5, wherein the electrical power emitting module electrically connects with the power supply, the electrical power emitting module emits electrical power provided by the power supply, and transmitted via the electrical wire.

8. The data transmission system of claim 1, wherein the second processor comprises a second data processing module, a second signal emitting module, and a second signal receiving module, the second signal emitting module and the second signal receiving module are electrically connected to the second data processing module, the second signal emitting module emits electrical signals to the second photoelectric conversion module, and the second photoelectric conversion module converts the electrical signals to optical signals to be transmitted by the at least one optical fiber; the second photoelectric conversion module converts the optical signals transmitted by the at least one optical fiber to electrical signals, and the second signal receiving module receives the electrical signals.

9. The data transmission system of claim 1, wherein the at least one electrical wire is capable of transmitting electrical power having a plurality of voltages.

10. The data transmission system of claim 1, wherein the signal transmitting cable further comprises at least one ground wire.

11. An optical data cable, comprising:
a first connecting member comprising a first photoelectric conversion module;
a second connecting member comprising a second photoelectric conversion module, and a signal transmitting cable connecting the first connecting member and the second transmitting member, the signal transmitting cable comprising at least one optical fiber and at least one electrical wire, the at least one optical fiber connecting with the first photoelectric conversion module and the second photoelectric conversion module, an end of the at least one electrical wire electrically connected to the second photoelectric conversion module;
wherein the at least one optical fiber is configured to transmit optical signals, the at least one electrical wire is configure to transmit electrical power to the second photoelectric conversion module, to start the second photoelectric conversion module.

12. The optical data cable of claim 11, wherein the at least one electrical wire is capable of transmitting electrical power of a plurality of voltages.

13. The optical data cable of claim 11, wherein the signal transmitting cable further comprises at least one ground wire.
